(19) United States
(12) Patent Application Publication
(10) Pub. No.: US 2024/0242265 A1
(43) Pub. Date: Jul. 18, 2024

(54) PROCESSING DEVICE, PROCESSING METHOD, AND PROCESSING PROGRAM

(71) Applicant: NTT QONOC, INC., Tokyo (JP)

(72) Inventor: Toshimitsu NAKAMURA, Chiyoda-ku (JP)

(73) Assignee: NTT QONOQ, INC., Tokyo (JP)

(21) Appl. No.: 18/558,936

(22) PCT Filed: Jun. 3, 2022
(86) PCT No.: PCT/JP2022/022622

§ 371 Date: Nov. 3, 2023

(30) Foreign Application Priority Data
Jun. 8, 2021 (JP) 2021-096002

(51) Int. Cl. G06Q 30/0601; G06T 17/00; G06V 20/52; G06V 40/20

(52) U.S. Cl. CPC G06Q 30/0643; G06T 17/00; G06V 20/53; G06V 40/20

(57) ABSTRACT

A server device (10) includes: a construction section (132) that constructs a VR shopping mall having VR stores where a user can browse and purchase products in a virtual space and provides the VR shopping mall to a user terminal used by the user; an image processing section (133) that acquires image information, which is obtained by monitoring a physical store that actually sells products displayed in a VR store, and processes the image information to acquire customer behavior information of the physical store; and a reflection processing section (134) that causes each user terminal to reflect the customer behavior information of the physical store into the VR store or the VR shopping mall.

### TECHNICAL FIELD

The present invention relates to a processing device, a processing method, and a processing program.

### BACKGROUND ART

Conventionally, it has become common to purchase products using a website (EC site (Electronic Commerce site)) that sells products on the Internet. In addition, in recent years, a technology has been proposed that recreates a store in a virtual space and links the store in the virtual space with the EC site to provide users with a purchasing experience similar to that of purchasing products in a physical store.

### CITATION LIST

### Patent Literature

Patent Literature 1: Japanese Unexamined Patent Publication No. 2004-220074

### SUMMARY OF INVENTION

### Technical Problem

In the physical store, a customer may be interested in a product held by another customer or a product that another customer is paying attention to. For this reason, in the actual physical store, products that are often picked up by customers or products that attract the attention of customers are actually purchased in many cases.

However, since the virtual store recreated in the virtual space is a closed space where products are displayed only for the user, the user cannot recognize the purchase situation in the physical store, such as hot-selling products in the physical store.

The present invention has been made in view of the above, and it is an object of the present invention to provide a processing device, a processing method, and a processing program for improving the user's willingness to purchase by reflecting the customer behavior information of a physical store into a virtual store or a virtual shopping mall recreated in a virtual space.

### Solution to Problem

In order to solve the aforementioned problem and achieve the object, a processing device of the present invention includes: a construction section that constructs a virtual shopping mall having virtual stores where a user can browse and purchase products in a virtual space and provides the virtual shopping mall to a user terminal used by the user; an image processing section that acquires image information, which is obtained by monitoring a physical store that actually sells products displayed in a virtual store, and processes the image information to acquire customer behavior information of the physical store; and a reflection processing section that causes each user terminal to reflect the customer behavior information of the physical store into the virtual store or the virtual shopping mall.

### Advantageous Effects of Invention

According to the present invention, it is possible to improve the user's willingness to purchase by reflecting the customer behavior information of the physical store into the virtual store or the virtual shopping mall recreated in the virtual space.

### BRIEF DESCRIPTION OF DRAWINGS

FIG. 1 is a block diagram showing an example of the configuration of a communication system according to an embodiment.

FIG. 2 is a diagram for explaining processing of a server device shown in FIG. 1.

FIG. 3 is a block diagram showing an example of the configuration of the server device shown in FIG. 1.

FIG. 4 is a diagram showing an example of a screen displayed on a user terminal.

FIG. 5 is a diagram showing an example of a screen displayed on a user terminal.

FIG. 6 is a diagram showing an example of a screen displayed on a user terminal.

FIG. 7 is a diagram showing an example of a screen displayed on a user terminal.

FIG. 8 is a diagram showing a display example of an advertisement area of a VR (Virtual Reality) store displayed on a user terminal.

FIG. 9 is a diagram showing an example of a screen displayed on a user terminal.

FIG. 10 is a sequence diagram showing a procedure of communication processing in the communication system according to the embodiment.

FIG. 11 is a diagram showing a computer executing a program.

### DESCRIPTION OF EMBODIMENTS

Hereinafter, embodiments of a processing device, a processing method, and a processing program according to the present application will be described in detail with reference to the diagrams. In addition, the processing device, the processing method, and the processing program according to the present application are not limited by the embodiments.

In the following embodiments, processing flows of the processing device, the processing method, and the processing program according to the embodiments will be described in order, and finally effects of the embodiments will be described.

### EMBODIMENTS

First, an embodiment will be described. In the embodiment, a communication system for providing users with a shopping environment in a virtual space will be described.

### [Configuration of Communication System]

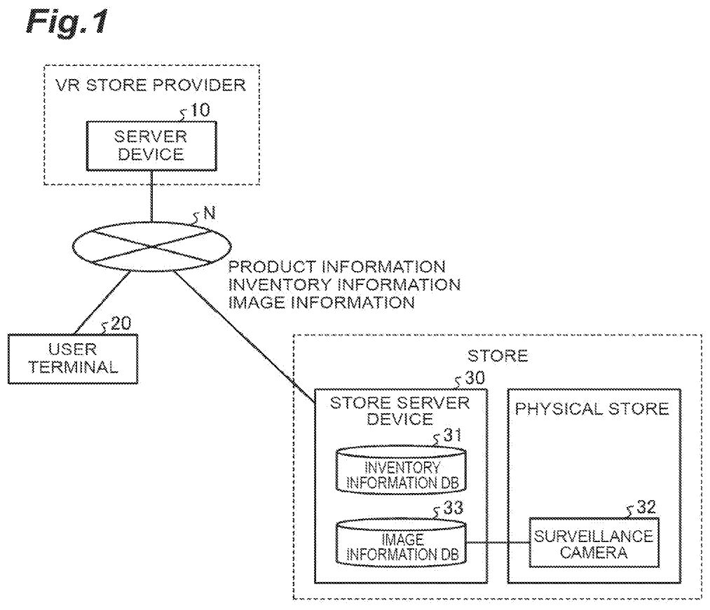

The configuration of the communication system according to the embodiment will be described. In the communication system according to the embodiment, a server device on a VR (Virtual Reality) store provider side providing a shopping environment to users constructs a VR store (virtual store) in the virtual space, and arranges products in the VR store for viewing and purchase. FIG. 1 is a block diagram showing an example of the configuration of the communication system according to the embodiment.

As shown in FIG. 1, the communication system according to the embodiment includes a user terminal 20 used by each user and a server device 10 (processing device) of a VR store provider. In addition, the server device 10 is linked to a store server device 30 in a store that sells products. In addition, the configuration shown in FIG. 1 is merely an example, and the specific configuration or the number of devices is not particularly limited.

The server device 10 of the VR store provider receives information on products that can be displayed in a VR store or advertisements from the store server device 30 in a physical store that actually sells the products displayed in the VR store, and provides users with the VR store where these products are displayed. In the VR store, the user can refer to product information such as product type, color, size, and price by selecting a product, and can proceed to product purchase processing by performing predetermined processing. In addition, the server device 10 can recreate a virtual town in the virtual space, construct a virtual shopping mall (VR shopping mall) in which a plurality of VR stores or street advertisements are arranged, in the virtual town, and provide the virtual shopping mall to the user.

The store server device 30 has an inventory information DB 31 of each held product. The store server device 30 transmits information on products that can be displayed in VR stores or advertisements among the held products to the server device 10 through a network N or the like. The store server device 30 transmits identification information, name, size, color, price, inventory information, and the like of each product as product information.

A surveillance camera 32 is installed in the physical store. The surveillance camera 32 monitors the physical store. The store server device 30 has an image information DB 33 that holds image information of the physical store captured by the surveillance camera 32. The store server device 30 transmits the image information held by the image information DB 33 to the server device 10 through the network N or the like.

The user terminal 20 is an information processing device such as a notebook PC (Personal Computer) or a desktop PC, or a smart device such as a tablet or a smartphone. The user terminal 20 is linked to the server device 10 through the network N, and receives provision of the VR store. By operating the user terminal 20, the user of the user terminal 20 browses products and advertisements or purchases a product in the provided VR store.

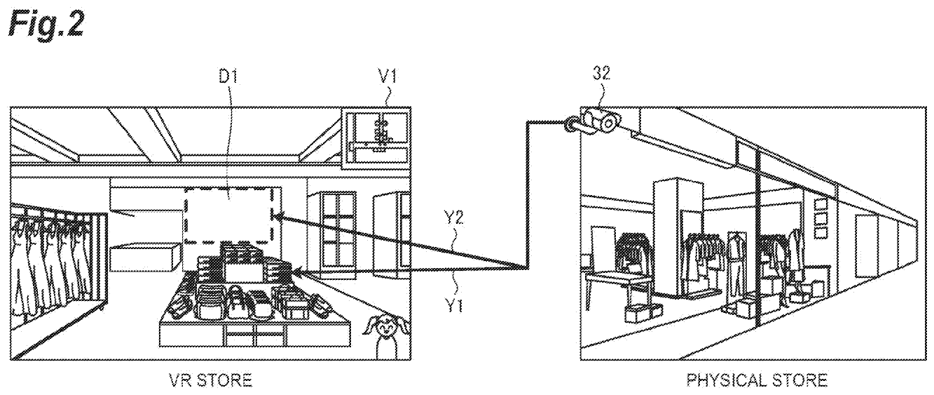

FIG. 2 is a diagram for explaining the processing of the server device 10 shown in FIG. 1. As shown in FIG. 2, the server device 10 acquires image information of the physical store captured by the surveillance camera 32 installed in the physical store, and processes the image information obtained by monitoring the physical store to acquire customer behavior information of the physical store. Then, the server device 10 causes each user terminal 20 to reflect the customer behavior information of the physical store into the VR store, as indicated by arrows Y1 and Y2 in FIG. 2. For example, as shown in a screen VI, the server device 10 reflects the customer behavior information of the physical store on products or an advertisement area DI into the VR store (see arrows Y1 and Y2). In addition, the server device 10 may cause each user terminal 20 to reflect the customer behavior information of the physical store into the VR shopping mall.

Therefore, by reflecting the customer behavior information of the physical store into the VR store and the VR shopping mall, for example, the user can recognize which product the customers are paying attention to based on the behaviors of the customers in the actual physical store. As a result, it is possible to improve the user's willingness to purchase. Next, the server device 10 shown in FIG. 1 will be described.

### [Server Device]

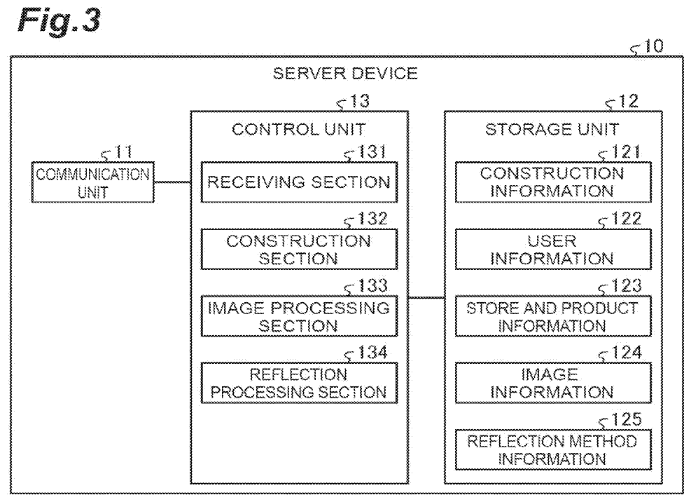

FIG. 3 is a block diagram showing an example of the configuration of the server device 10 shown in FIG. 1. As shown in FIG. 3, the server device 10 includes: a communication unit 11 for controlling communication related to various kinds of information; a storage unit 12 for storing data and programs required for various processes of a control unit 13; and the control unit 13 that executes various processes. Processing of each unit of the server device 10 will be described below.

The communication unit 11 is a communication interface for transmitting and receiving various kinds of information to and from other devices linked through a network or the like. The communication unit 11 is implemented by an NIC (Network Interface Card) or the like, and performs communication between another device and the control unit 13 (described later) through an electric communication line, such as a LAN (Local Area Network) or the Internet. For example, the communication unit 11 receives information on products that can be displayed from the store server device 30 through the network. In addition, the communication unit 11 receives, from the user terminal 20 through the network N, a request to enter the VR store, a request to view or purchase a product, and operation information of each user for the VR store. The communication unit 11 transmits information regarding product purchase procedures and inventory update after product purchase, to the store server device 30.

The storage unit 12 is a storage device such as an HDD (Hard Disk Drive) and an SSD (Solid State Drive). In addition, the storage unit 12 may be a data rewritable semiconductor memory, such as a RAM (Random Access Memory), a flash memory, and an NVSRAM (Non-Volatile Static Random Access Memory). The storage unit 12 stores an OS (Operating System) or various programs executed by the server device 10. In addition, the storage unit 12 stores various kinds of information used in executing the programs. The storage unit 12 stores construction information 121, user information 122, store and product information 123, image information 124, and reflection method information 125.

The construction information 121 is information required to construct a VR store and a VR shopping mall in the virtual space. The construction information 121 includes image processing conditions or image processing programs for constructing the VR store and the VR shopping mall in the virtual space. In addition, the construction information 121 includes, for example, photographs taken at fixed points or 360° of store interiors, products, streets, and store exteriors by the VR store and the VR shopping mall or images of the VR store and the VR shopping mall constructed by image-processing the photographs. For example, when the VR store and the VR shopping mall are constructed by CG (Computer Graphics), the construction information 121 is an image that recreates store interiors, products, streets, and store exteriors.

The user information 122 is information regarding each user registered as a visitor of the VR store and the VR shopping mall. The user information 122 includes, for example, user IDs and purchase histories and browsing histories associated with each user ID. For example, the purchase history has items of purchase time, name of the store where the product was purchased, product ID, product name, size, color, and quantity. For example, the browsing history has items of browsing time, name of the store where the product was browsed, product ID, product name, size, color, and quantity.

The store and product information 123 is information regarding stores recreated in the VR shopping mall and products displayed in the VR store. The store and product information 123 has items of store ID, store type, and product ID, product name, size, color, and quantity of products that can be displayed in the VR store or advertisements among the products held by each store. For example, a store P is a miscellaneous goods store, and displayable products, cutlery, and cups are shown together with other characteristics (such as sizes and colors) of these products and the quantity in stock.

The image information 124 is image information of the physical store captured by the surveillance camera 32. The image information 124 is transmitted from the store server device 30 through the network N or the like.

The reflection method information 125 is information indicating various methods for reflecting the customer behavior information of the physical store into the VR store or the VR shopping mall. The reflection method information 125 includes, as reflection methods, a method of displaying information indicating that a product is being browsed or tried on by a customer, a method of displaying the degree of congestion, a method of displaying video information of a physical store, and a method of highlighting each VR store in a VR shopping mall according to the degree of congestion of a physical store. In addition, the information indicating that a product is being tried on can also be acquired by using tag information or the like. For example, when an RFID tag or the like is attached to a product, information indicating that the product is being tried on is acquired as behavior information by causing a reader in a fitting room to read the tag information.

The control unit 13 performs overall control of the server device 10. The control unit 13 is, for example, an electronic circuit such as a CPU (Central Processing Unit) or an MPU (Micro Processing Unit), or an integrated circuit such as an ASIC (Application Specific Integrated Circuit) or an FPGA (Field Programmable Gate Array). In addition, the control unit 13 has an internal memory for storing programs defining various processing procedures or control data, and performs each processing by using the internal memory. In addition, the control unit 13 functions as various processing units by running various programs. The control unit 13 has a receiving section 131, a construction section 132, an image processing section 133, and a reflection processing section 134.

The receiving section 131 receives the user's entry into the VR shopping mall, entry into the VR store in the VR shopping mall, browsing of products, and purchase of products.

The construction section 132 constructs a VR store or a VR shopping mall in the virtual space using images or CG. Upon receiving the user's entry into the VR store, the construction section 132 constructs the VR store in the virtual space. Then, the construction section 132 provides the constructed VR store to the user terminal 20 used by the user.

In the VR store, the interior is constructed based on the physical store, and products that can be displayed among the products held by the physical store are displayed in a display manner (for example, arranged in a line on a display shelf) in the physical store. Then, for the displayed products, product information (type, color, shape, size, price, and inventory status) is provided so as to be able to be browsed. The displayed products can also be purchased. In addition, in the VR store, advertisements of products and the like displayed in the store can also be displayed in any area within the store. In the VR store, users can move their avatars as if walking through the physical store.

Then, upon receiving the user's entry into the VR shopping mall, the construction section 132 may acquire the construction information 121 and construct the VR shopping mall in the virtual space. In the VR shopping mall, the layout of each store, the appearance of each store, roads, and street advertisements are constructed based on the actual streets, the actual shopping mall, or the floor guide and floor map of the actual department store. In the VR shopping mall, each user can move the user's avatar as if walking through the actual street. Then, in the VR shopping mall, for example, the user can enter the selected VR store by clicking or tapping the store name displayed on the store exterior or the entrance of the store.

In addition, the construction section 132 may construct each VR store arranged in the VR shopping mall together with the VR shopping mall when receiving the user's entry into the VR shopping mall. In addition, the construction section 132 may change the street scenery in the VR shopping mall, products displayed in the VR store, and products displayed in the advertisement for each season.

The image processing section 133 acquires image information obtained by monitoring a physical store that actually sells the products displayed in the VR store, and processes the image information to acquire customer behavior information of the physical store.

The reflection processing section 134 causes each user terminal 20 to reflect the customer behavior information of the physical store into the VR store or the VR shopping mall. The reflection processing section 134 selects a method for reflection into the VR store or the VR shopping mall from the reflection method information 125. The reflection processing section 134 selects a method of reflection into the VR store or the VR shopping mall according to an instruction from the user of the user terminal 20 or based on a predetermined selection rule.

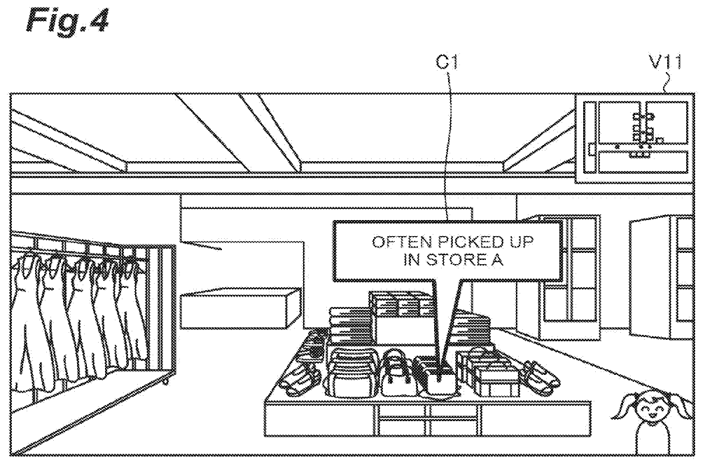

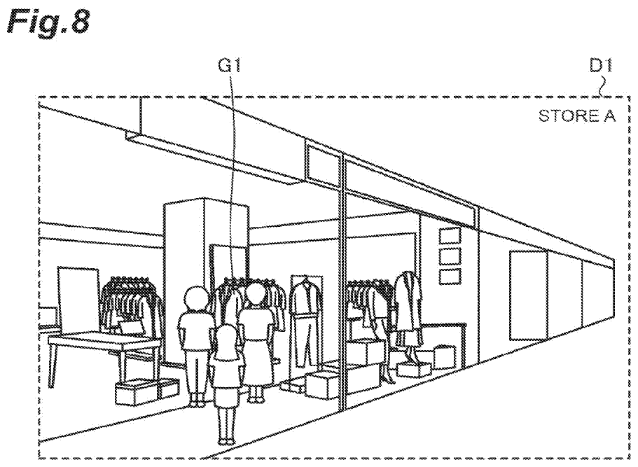

Hereinafter, specific processing of the image processing section 133 and the reflection processing section 134 will be described below with reference to FIGS. 4 to 9. FIGS. 4 to 7 and 9 are diagrams showing examples of the screen displayed on the user terminal 20. FIG. 8 is a diagram showing a display example of the advertisement area of the VR store displayed on the user terminal 20.

### Reflection Example 1

The image processing section 133 acquires, as the customer behavior information of the physical store, the product browsing behavior of the customer in the physical store and the product trying-on behavior of the customer in the physical store. For example, from the image information, the image processing section 133 acquires the customer's behavior of picking up the product and the customer's behavior of trying on the product. Then, for a first product that has been browsed (for example, picked up) or tried on a predetermined number of times or more by customers in the physical store among the products arranged in the VR store, the reflection processing section 134 causes each user terminal 20 to display information indicating that the product has been browsed or tried on by customers on the VR store.

Specifically, as shown in a screen V11 in FIG. 4, for a product that has been browsed or tried on a predetermined number of times or more by customers in the physical store among the products arranged in the VR store, the reflection processing section 134 displays a comment C1 pointing to the product. In the comment C1, for example, comments such as “often picked up in store A” and “often tried on in store A” are displayed. The reflection processing section 134 may display a comment “selling well in store A” based on the purchase history or inventory information of this store. In addition, the comment may have contents specifying a store such as store A, or may have contents determined by summing up a plurality of stores. In addition, if the number of sales of a product is counted for each store and the number of sales of the product in a plurality of stores exceeds a predetermined number, other comments, for example, a comment that lists store names (“selling well in store A and store B”) or a comment “selling well in three stores” may be displayed. Then, if the user focuses on the area where there is a store where the number of sales exceeds a predetermined number, a comment “selling well in the Kanto area” may be displayed. Alternatively, a user-friendly store (for example, store A) may be selected and a comment “selling well in store A” may be displayed.

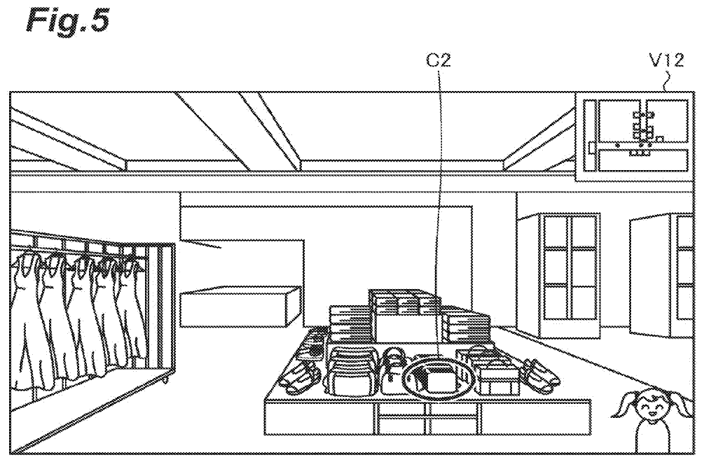

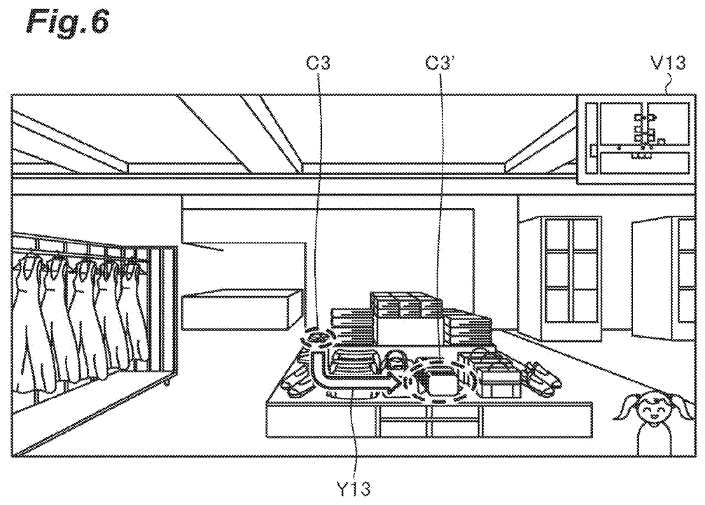

In addition, as shown in a screen V12 in FIG. 5, the reflection processing section 134 may highlight a product that has been browsed or tried on a predetermined number of times or more by customers in the physical store among the products arranged in the VR store, by surrounding the product with a frame C2 or the like. In addition, as indicated by an arrow Y13 on the screen V13 in FIG. 6, the reflection processing section 134 may change the display position of the product that has been browsed or tried on a predetermined number of times or more by customers in the physical store, among the products arranged in the VR store, from a position C3 at the back of the screen to a position C3′ (for example, the center of the screen) on the line of sight of the user. The user's line-of-sight information can be acquired from the user's line-of-sight angle information through the VR goggles.

As a result, the user can easily recognize which of the products in the VR store is often browsed or tried on by customers in the physical store. This can be used as a basis for making a decision on the purchase of a product.

### Reflection Example 2

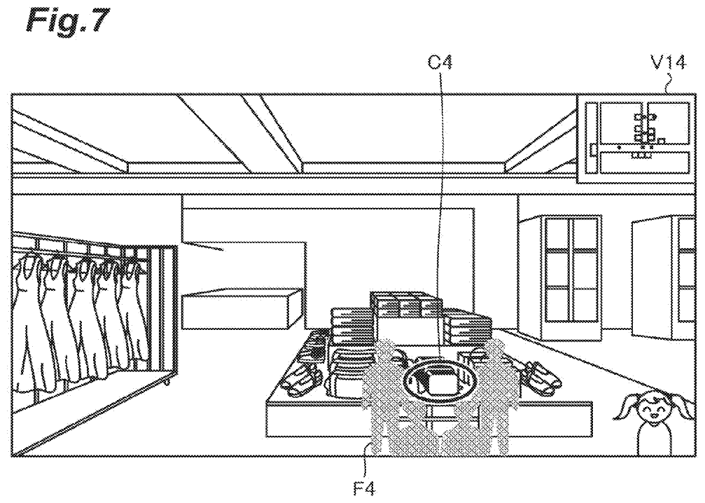

In addition, the image processing section 133 may acquire the degree of congestion of customers in a physical store as the customer behavior information of the physical store by processing the image information. In this case, as shown in a screen V14 in FIG. 7, the reflection processing section 134 may cause each user terminal 20 to display silhouette images F4, the number of which corresponds to the degree of congestion, in the VR store. Then, the reflection processing section 134 may highlight a product that actually attracts customers in the physical store by surrounding the product with a frame C4 or the like. In addition, the reflection processing section 134 adjusts the arrangement of the silhouette images F4 so that the product can be easily viewed on the VR store.

As a result, the user can easily recognize which of the products in the VR store attracts customers in the physical store. This can be used as a basis for making a decision on the purchase of a product. In addition, since the user can determine the degree of congestion of the physical store, the user can also know the degree of popularity of the store. This can be used as a basis for making a decision on the purchase of a product.

### Reflection Example 3

In addition, the image processing section 133 may acquire video information of the physical store as the customer behavior information of the store. The image processing section 133 cuts out only the area where customers are gathered from the video information of the physical store. In addition, the video information does not have to be in real time. For example, in addition to the current video information, information at a predetermined time (for example, 14:00), video information of the previous day, video information of the weekend, and the like are selected as video information on the device side. In addition, the user can also select the video information.

Then, the reflection processing section 134 causes each user terminal 20 to display the video information processed by the image processing section 133 together with the store information (for example, “store A”) in the advertisement area (for example, the advertisement area DI in FIG. 8) arranged in the VR store. In addition, the reflection processing section 134 processes the video image so that the person appearing in the video image cannot be specified. In addition, the reflection processing section 134 may display a video image, in which a scene where people are gathered and a scene where a product G1 is shown are combined, in the advertisement area of the VR store so that the product can be easily viewed on the VR store.

As a result, the user can easily recognize which of the products in the VR store attracts customers in the physical store. This can be used as a basis for making a decision on the purchase of a product.

### Reflection Example 4

In addition, the image processing section 133 acquires, as the customer behavior information of the physical store, the degree of congestion of customers in each physical store corresponding to each VR store opened in the VR shopping mall. Then, the reflection processing section 134 causes each user terminal 20 to highlight each VR store in the VR shopping mall according to the degree of congestion of each corresponding physical store.

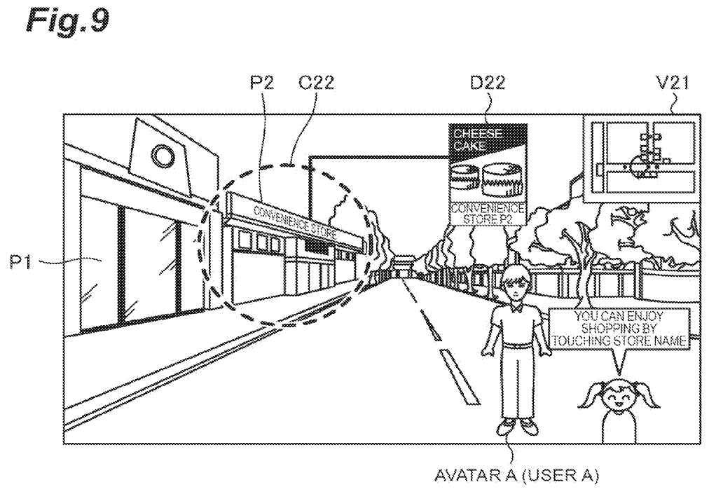

For example, as shown in a screen V21 in FIG. 9, the reflection processing section 134 highlights a store P2 having a higher degree of congestion between stores P1 and P2 by surrounding the store P2 with a frame C22. In addition, the reflection processing section 134 may display the degree of congestion by displaying the heat map of each VR store. In addition, the reflection processing section 134 may display products of the store P2 having a higher degree of congestion in the advertisement D22 of the VR shopping mall. At this time, the reflection processing section 134 may display products that are often browsed by customers in the physical store, among the products of the store P2, in the advertisement D22 based on the processing result of the image processing section 133.

As a result, the user can easily recognize a VR store whose physical store actually gathers customers in the VR shopping mall. This can be used as a basis for deciding whether or not to enter the store.

### [Procedure of Communication Processing]

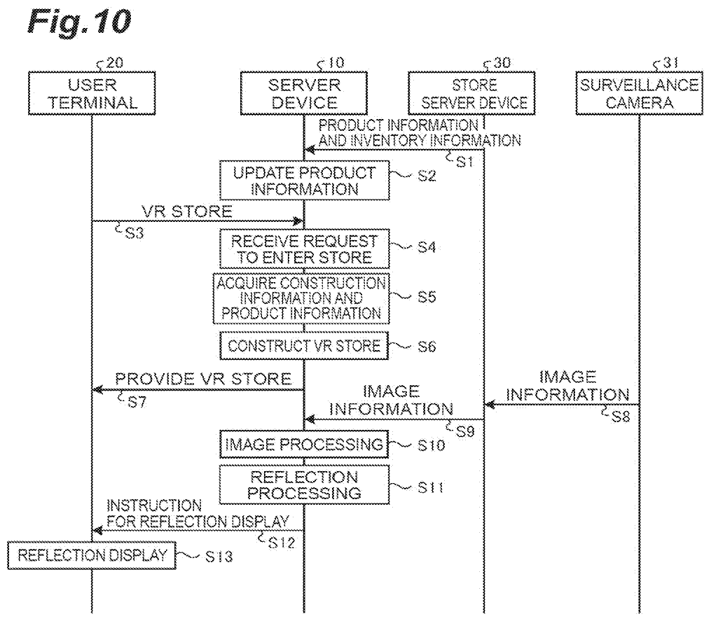

FIG. 10 is a sequence diagram showing a procedure of communication processing in the communication system according to the embodiment.

As shown in FIG. 10, when product information and inventory information are received from the store server device 30 (step S1), the server device 10 updates the store and product information 123 (step S2).

In the server device 10, when the receiving section 131 receives a request to enter the VR store from the user terminal 20 (steps S3 and S4), the construction section 132 acquires the construction information 121 and the store and product information 123 (step S5) and constructs the VR store in the virtual space (step S6). Then, the construction section 132 provides the VR store to the user terminal 20 (step S7). In addition, the construction section 132 may construct a VR shopping mall in the virtual space and provide the VR shopping mall to the user terminal 20.

The store server device 30 acquires image information obtained by monitoring the physical store from the surveillance camera 32 provided in the physical store (step S8), and transmits the image information to the server device 10 (step S9). In the server device 10, the image processing section 133 performs image processing for acquiring customer behavior information of the physical store by processing the image information obtained by monitoring the physical store (step S10).

In the server device 10, the reflection processing section 134 performs reflection processing for reflecting the customer behavior information of the physical store into the VR store or the VR shopping mall in each user terminal 20 (step S11), and transmits an instruction for reflection display on the VR store, which is displayed on the screen, to the user terminal 20 (step S12). Based on the reflection display instruction from the server device 10, the user terminal 20 displays, on the screen, information reflecting the customer behavior information of the physical store (step S13).

### Effects of the Embodiment

As described above, the server device 10 according to the embodiment acquires image information obtained by monitoring the physical store that actually sells the products displayed in the VR store, and processes the image information to acquire the customer behavior information of the physical store. Then, the server device 10 causes each user terminal 20 to reflect the customer behavior information of the physical store into the VR store or the VR shopping mall.

As a result, the user can easily recognize which of the products in the VR store are often browsed or tried on by customers in the physical store and which product attracts customers. This can be used as a basis for making a decision on the purchase of a product. In addition, the user can easily recognize a VR store whose physical store actually gathers customers in the VR shopping mall. This can be used as a basis for deciding whether or not to enter the store. Therefore, according to the present embodiment, the user's willingness to purchase can be improved by reflecting the customer behavior information of the physical store into the VR store or the VR shopping mall recreated in the virtual space.

### [System Configuration and the Like]

In addition, each component of each device shown in the diagrams is functionally conceptual, and does not necessarily have to be physically configured as shown in the diagrams. That is, the specific form of distribution and integration of respective devices is not limited to those shown in the diagrams, and all or some of the devices can be functionally or physically distributed and integrated in arbitrary units according to various loads or the working condition. In addition, all or any part of each processing function executed by each device can be realized by a CPU or GPU (Graphics Processing Unit) and a program that is analyzed and executed by the CPU or GPU, or can be realized as hardware by wired logic.

In addition, among the processes described in the present embodiment, all or some of the processes described as being automatically performed can be performed manually, or all or some of the processes described as being manually performed can be performed automatically by using a known method. In addition, information including processing procedures, control procedures, specific names, and various kinds of data or parameters shown in the above document or diagrams can be arbitrarily changed unless otherwise specified.

### [Program]

In addition, it is also possible to create a program in which the processing executed by the server device 10 described in the above embodiment is described in a computer-executable language. For example, it is also possible to create a program in which the processing executed by the server device 10 in the embodiment is described in a computer-executable language. In this case, the same effects as in the embodiment described above can be obtained by the computer executing the program. In addition, such a program may be recorded in a computer-readable recording medium, and the program recorded in this recording medium may be read and executed by a computer to realize processing similar to that in the embodiment described above.

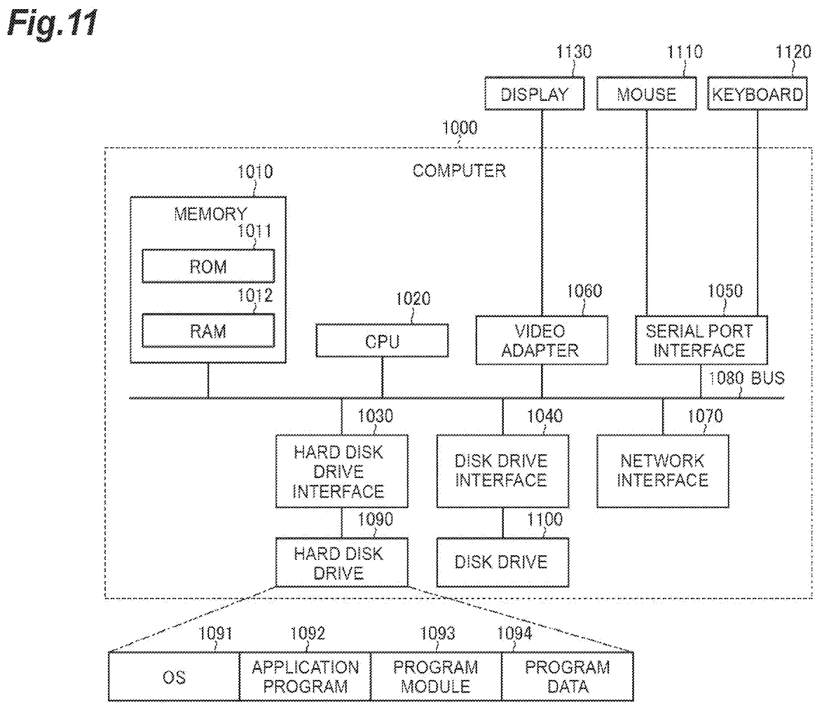

FIG. 11 is a diagram showing a computer executing a program. As illustrated in FIG. 11, a computer 1000 includes, for example, a memory 1010, a CPU 1020, a hard disk drive interface 1030, a disk drive interface 1040, a serial port interface 1050, a video adapter 1060, and a network interface 1070, and these units are linked to each other by a bus 1080.

The memory 1010 includes a ROM (Read Only Memory) 1011 and a RAM 1012 as illustrated in FIG. 11. The ROM 1011 stores a boot program such as BIOS (Basic Input Output System). The hard disk drive interface 1030 is linked to a hard disk drive 1090 as illustrated in FIG. 11. The disk drive interface 1040 is linked to a disk drive 1100. A removable storage medium such as a magnetic disk or an optical disk is inserted into the disk drive 1100. The serial port interface 1050 is linked to a mouse 1110 and a keyboard 1120, for example. The video adapter 1060 is linked to a display 1130, for example.

Here, as illustrated in FIG. 11, the hard disk drive 1090 stores an OS 1091, an application program 1092, a program module 1093, and program data 1094, for example. That is, the above program is stored, for example, in the hard disk drive 1090 as a program module in which instructions to be executed by computer 1000 are described.

In addition, various kinds of data described in the above embodiment are stored as program data, for example, in the memory 1010 or the hard disk drive 1090. Then, the CPU 1020 reads the program module 1093 or the program data 1094 stored in the memory 1010 or the hard disk drive 1090 to the RAM 1012 as necessary to execute various processing procedures.

In addition, the program module 1093 or the program data 1094 related to the program is not limited to being stored in the hard disk drive 1090, and may be stored in a removable storage medium and read by the CPU 1020 through a disk drive or the like, for example. Alternatively, the program module 1093 or the program data 1094 related to the program may be stored in another computer linked through a network (LAN (Local Area Network), WAN (Wide Area Network), and the like) and read by the CPU 1020 through the network interface 1070.

The embodiment and its modifications described above are included in the scope of the invention described in the claims and their equivalents, as well as in the technology disclosed by the present application.

### REFERENCE SIGNS LIST

10: server device, 11: communication unit, 12: storage unit, 13: control unit, 20: user terminal, 30: store server device, 121: construction information, 122: user information, 123: store and product information, 124: image information, 125: reflection method information, 131: receiving section, 132: construction section, 133: image processing section, 134: reflection processing section.

1. A processing device, comprising:
a construction section that constructs a virtual shopping mall having virtual stores where a user can browse and purchase products in a virtual space and provides the virtual shopping mall to a user terminal used by the user;
an image processing section that acquires image information, which is obtained by monitoring a physical store that actually sells products displayed in a virtual store, and processes the image information to acquire customer behavior information of the physical store; and
a reflection processing section that causes each user terminal to reflect the customer behavior information of the physical store into the virtual store or the virtual shopping mall.

2. The processing device according to claim 1,
wherein the image processing section acquires, as the behavior information, a product browsing behavior of a customer in the physical store and a product trying-on behavior of a customer in the physical store, and
for a first product that has been browsed or tried on a predetermined number of times or more by customers in the physical store among products arranged in the virtual store, the reflection processing section causes each user terminal to display information indicating that the product has been browsed or tried on by customers.

3. The processing device according to claim 2,
wherein, for the first product, the reflection processing section displays a comment indicating that the first product has been browsed or tried on by customers, highlights the first product, or changes a display position of the first product onto a line of sight of the user.

4. The processing device according to claim 1,
wherein the image processing section acquires a degree of congestion of customers in the physical store as the behavior information, and
the reflection processing section causes each user terminal to display silhouette images, the number of which corresponds to the degree of congestion, in the virtual store.

5. The processing device according to claim 1,
wherein the image processing section acquires video information of the physical store as the behavior information, and
the reflection processing section causes each user terminal to display the video information in an advertisement area arranged in the virtual store.

6. The processing device according to claim 1,
wherein the image processing section acquires, as the behavior information, a degree of congestion of customers in each physical store corresponding to each virtual store opened in the virtual shopping mall, and
the reflection processing section causes each user terminal to highlight each virtual store in the virtual shopping mall according to the degree of congestion of each corresponding physical store.

7. A processing method executed by a processing device, comprising:
a step of constructing a virtual shopping mall having virtual stores where a user can browse and purchase products in a virtual space and providing the virtual shopping mall to a user terminal used by the user;
a step of acquiring image information, which is obtained by monitoring a physical store that actually sells products displayed in a virtual store, and processing the image information to acquire customer behavior information of the physical store; and
a step of causing each user terminal to reflect the customer behavior information of the physical store into the virtual store or the virtual shopping mall.

8. A processing program causing a computer to execute:
a step of constructing a virtual shopping mall having virtual stores where a user can browse and purchase products in a virtual space and providing the virtual shopping mall to a user terminal used by the user;
a step of acquiring image information, which is obtained by monitoring a physical store that actually sells products displayed in a virtual store, and processing the image information to acquire customer behavior information of the physical store; and
a step of causing each user terminal to reflect the customer behavior information of the physical store into the virtual store or the virtual shopping mall.
